(19) United States
(12) Patent Application Publication
(10) Pub. No.: US 2009/0194957 A1
(43) Pub. Date: Aug. 6, 2009

(54) Multifuctional transport frame for the convertible assembly of various child transport devices or vehicles

(76) Inventor: Thomas Hugo Schneegans, Weil am Rhein (DE)

Correspondence Address: SPECKMAN LAW GROUP PLLC, 1201 THIRD AVENUE, SUITE 330, SEATTLE, WA, 98101, US

(21) Appl. No.: 11/988,985

(22) PCT Filed: Jan. 10, 2006
(86) PCT No.: PCT/DE2006/000023

§ 371 Date: Jan. 16, 2008

(30) Foreign Application Priority Data
Jan. 16, 2005 (DE) 10 2005 002 216.2
Dec. 4, 2005 (DE) 10 2005 058 026.2

(51) Int. Cl. B62B 7/12

(52) U.S. Cl. 280/31

(57) ABSTRACT

Conventionally, prams and the classic first child vehicles were independent devices. The disclosed frame permits the production and operation of the series of vehicles used by children of the western world: pram, pushchair, walking learning aid, three-wheeler, go-kart and additional corresponding trailer or hand carts as a modular system. Essential components of said transport frame are of multiple or universal application.

### REFERENCE TO RELATED APPLICATIONS

This application claims priority under 35 USC §371 of International Patent application no. PCT/DE2006/000023, filed Jan. 10, 2006, which claims priority to German patent applications no. DE 10 2005 002 216.2 filed Jan. 16, 2005 and DE10 2005 058 026.2, filed Dec. 4, 2005.

### FIELD OF THE INVENTION

The present invention relates to a multifunctional chassis for child transport devices and/or vehicles.

### BACKGROUND OF THE INVENTION

Currently, diverse child transport devices and/or vehicles are on the market, which are largely designed as monofunctional in their types and properties, such as prams, strollers, tricycles, walking learning aids, go-carts, trailers, hand carts, etc. Although all of these devices have multiple wheels which are connected to one another via a chassis, this chassis is used jointly only in combination models of prams and strollers. Other advisable connections have been unknown up to this point and are not available on the market.

Particularly in view of the increase in single-child families and lower household incomes, it is appropriate to offer stable and cost-effective solutions for the above-mentioned articles of use during the physical growth of small children.

### SUMMARY OF THE INVENTION

The present invention presents a multifunctional chassis that may be converted into vehicle types, including strollers, walking learning aids, tricycles (adequate vehicle), go-carts, trailers, and hand carts, stably, cost-effectively and in high-quality form.

More specifically, the present invention provides a chassis for child transport devices and/or vehicles characterized in that the chassis as a whole or at least an essential part of its frame or its wheels, may, as a result of its modular construction, be used both as a pram and/or stroller (FIGS. 6-7), and also as at least one child transport device or vehicle, such as a walking learning aid (FIG. 5), tricycle (FIG. 10), go-cart (FIGS. 11-12), bicycle trailer (FIGS. 8-9), or a vehicle similar to a hand cart, and/or a vehicle functionally replacing at least one of such vehicles. Alternatively, the chassis may be used not in the combination of pram and stroller (FIGS. 6-7), but in any other possible combination of the vehicles disclosed herein.

In certain embodiments, the chassis disclosed herein contains a pedal drive (FIGS. 13-14, 19) operable by the child, or is modularly constructed and may optionally be supplemented with such a drive. The pedal drive may contain at least one driveshaft (FIGS. 13-14, 20-21), which may be inserted and fixed in regard to its mounting position without further tools.

In certain embodiments, the at least one driveshaft (FIGS. 13-14, 20-21) is designed as being elastic in a rotational and/or bending direction, for example by using hard rubber as a material or by design as a so-called flexible shaft or torsion spring.

In certain embodiments, the pedal drive (FIGS. 13-14, 19) operable by the child has a freewheel which may be switched in or is permanent. The pedal drive (FIGS. 13-14, 19) may also, or alternatively, contain a stepped or continuously variable transmission.

In certain embodiments, the pedal drive (FIGS. 13-14, 19) operable by the child solely transmits the force using one wheel, even if at least one further wheel is situated parallel or on the same axle to this wheel in the chassis.

In certain embodiments, the chassis for child transport devices and/or vehicles disclosed herein contains a steering device (FIGS. 13+15, 12-18) operable by the child or is modularly constructed and may be optionally be supplemented by such a device. The steering device operable by the child may be varied continuously or graduated in height and/or length and fixed in at least two positions via telescopic extension, cable pull, or other suitable technical means. In certain embodiments, the steering device operable by the child may be varied continuously or graduated in its inclination using a pivot bracket, a functionally-identical linear telescoping rod having joints on both sides, or another type of pivot mechanism, and fixed. In further embodiments, the steering device operable by the child contains at least one propeller joint, a flexible shaft, a gearwheel pair, or another pair of elements which preferably has a non-positive and/or friction-locked connection.

In certain embodiments, the disclosed chassis for child transport devices and/or vehicles is provided with steerable wheels (FIGS. 4 and 12-14) that may be locked in regard to their steering ability via suitable technical means such as screws, bolts, alignment pins, closure mechanisms, e.g., for operation as a pram and stroller or walking learning aid chassis.

In certain embodiments, the chassis for child transport devices and/or vehicles disclosed herein may be folded up for transport and/or storage or at least disassembled into space-saving and easily transportable parts, preferably without the use of further tools.

In yet further embodiments, the disclosed chassis for child transport devices and/or vehicles according is equipped with corresponding receptacles and fastening capabilities such as carrier, pivot, and spring brackets (FIGS. 3-4+6-10, 1-3 and FIGS. 11+12, 2) or adjustable saddle supports (FIG. 5) for the typical add-ons to be mounted for the particular use, such as a bed for prams (FIG. 6, 7), a reclining seat for strollers (FIGS. 7, 8), a bed or reclining seat for baby trailer (bicycle trailer) (FIG. 8), and/or typical seating capabilities such as saddle or trouser safety seat (FIG. 14, 10) for walking learning aid (FIG. 5), saddle (FIG. 10, 6) for vehicle (FIG. 10) adequate as a tricycle, or shell seat for vehicle (FIGS. 11-12) adequate as a go-cart.

In certain embodiments, the typical seating capabilities to be mounted for the particular use, such as saddle or trouser safety seat (FIG. 14, 10) or walking learning aid (FIG. 5, 6), saddle for vehicle adequate as a tricycle (FIG. 10, 6), or shell seat for vehicle (FIGS. 11-12, 9) adequate as a go-cart, may be adapted to the body size of the child in regard to differing positioning using oblong holes, multiple receptacle holes, telescoping devices, pivot mechanisms, etc.

In further embodiments, a single element (FIGS. 2-10+13-14, 1 and FIGS. 11-12, 2), which is adjustable in its length and/or inclination, is implemented as an essential support or even as the only required receptacle for at least multiple of the typical add-ons (bed—FIG. 6, 7 and reclining seat—FIG. 7, 8) or seating capabilities (saddle—FIGS. 5+10, 6, trouser safety seat—FIG. 14, 10 and shell seat—FIGS. 11-12, 9) to be mounted for the particular use.

In certain embodiments, the chassis for child transport devices and/or vehicles disclosed herein is equipped with a brake system, which is operable from multiple or various points via operating elements (lever—FIG. 10, 25 and FIGS. 11-12, 26, Bowden pull wires, rods, etc.), which are mounted fixed and/or replaceable for specific applications, and thus—preferably as a function of the use of the chassis—may be actuated by the accompanying person, by the child, or by both jointly. For simultaneous operability by the accompanying person and the child, the operating elements of the brake system may be linked to one another in such a way that a priority for the operation of the brake advisable for the specific application results (typically in favor of the accompanying person), for example, by decoupling the subordinate operating element by the main operating element, in that the main operating element first actuates a corresponding coupling element—also designed as lockable in this position if needed—in the range of its idle stroke path and only applies the braking force to the brake elements in the course of the further operating path.

In certain embodiments, the chassis for child transport devices and/or vehicles is equipped with a push bracket (FIGS. 2-7+13, 4), which is removable and/or adjustable in regard to length and/or inclination. Such a removable push bracket (FIGS. 2-7+13, 4) may also be mounted in the event of use of the product as a walking learning aid (FIG. 5) and/or child vehicle (FIGS. 10-11, not shown). The push bracket (FIGS. 2-7+13, 4) may simultaneously or alternatively fulfill the function of a rollover bracket in at least one lockable position for at least one modularly constructible vehicle.

In certain embodiments, the chassis for child transport devices and/or vehicles has an axial distance and/or vehicle length that are designed to be varied using a telescopic extension (FIGS. 2-13, 11) or a comparable suitable technical device.

In yet further embodiments, at least two wheels of the chassis are suspended thereon individually sprung.

In certain embodiments, at least the wheel(s) of the front and/or rear axle of the chassis are mounted so that they are rotatable on a suspension which is vertical in the operating state of the chassis.

In certain embodiments, the chassis for child transport devices and/or vehicles is provided with suspension which is vertical in the operating state of the chassis and is fixed in regard to its ability to rotate using a suitable technical device (screws, bolts, formfitting clamps, etc.). Such suspension may be replaced with one which is not rotatable.

The chassis for child transport devices and/or vehicles disclosed herein may be provided with at least one fastening receptacle for attaching at least one transport container.

The disclosed chassis for child transport devices and/or vehicles may be modularly implemented in such a way that (at least) one axle may be replaced by a correspondingly implemented drawbar (FIGS. 8+9, 22) in a form in which a bicycle trailer (FIG. 8) (or also a trailer usable in another way) may be prepared essentially from one or also multiple of the other vehicles (FIGS. 5-7+10-11). In certain embodiments, the correspondingly implemented drawbar (FIGS. 8+9, 22) is designed as adjustable in its type and/or length via telescopic extensions (FIGS. 8, 11+27) and/or is flanged on via a telescopic extension preferably provided in the chassis. The drawbar may be provided with a stand (FIG. 8, 28), which may be folded down or lowered in another way, and may additionally or alternatively, provided with a retainer for a tray or a similar shelf.

In certain embodiments, the chassis for child transport devices and/or vehicles is provided with a drawbar module which may be inserted into a steerable axle in such a way that it steers the axle and thus converts the vehicle into a corresponding steered trailer or vehicle similar to a hand cart. Alternatively, a drawbar module having a steering axle may replace at least one existing axle and thus convert the vehicle into a corresponding steered trailer or vehicle similar to a hand cart.

### BRIEF DESCRIPTION OF THE FIGURES

FIG. 1 shows a multifunctional chassis in cross-section with an overall illustration of all child vehicles resulting therefrom,

FIG. 2 shows the multifunctional chassis in the folded-up state,

FIG. 3 shows the multifunctional chassis in the erected state,

FIG. 4 shows the multifunctional chassis from FIG. 3 in a top view,

FIG. 5 shows a walking learning aid constructed from the multifunctional chassis,

FIG. 6 shows a pram constructed from the multifunctional chassis,

FIG. 7 shows a stroller constructed from the multifunctional chassis,

FIG. 8 shows a baby trailer constructed from the multifunctional chassis,

FIG. 9 shows a baby trailer of FIG. 8 in a top view,

FIG. 10 shows a child vehicle, which is adequate as a tricycle, constructed from the multifunctional chassis,

FIG. 11 shows a go-cart constructed from the multifunctional chassis,

FIG. 12 shows the go-cart from FIG. 11 in a top view,

FIG. 13 shows the assembly of the multifunctional chassis as a child vehicle having a pedal drive module in a perspective view and partially in an exploded illustration,

FIG. 14 shows the assembled child vehicle of FIG. 13 having a shopping basket, and

FIG. 15 shows a detail of the pivotable steering column with a pivot bracket in a perspective illustration.

### DETAILED DESCRIPTION

The present invention provides a chassis for child transport devices and/or vehicles having a modular basic construction, which is distinguished by sufficient adjustability. In addition, it contains corresponding receptacle and fastening capabilities for function-specific parts for simple mounting of the different required add-ons as a function of the desired usage of the vehicle. As is recognizable from the attached drawings due to the design of the chassis, even a few simple technical elements, such as brackets which are adjustable by pivoting and in length, are sufficient to fix diverse seats and add-ons variably in regard to their vertical and/or horizontal position, as well as telescopic mechanisms, for example, to vary the axial distance of the chassis. Additional force-transmitting joints, and telescopic and pivot mechanisms adapt the steering column to the particular intended purpose in regard to inclination and length. The possibility thus results of using such a chassis over many years in spite of significant physical growth of the child.

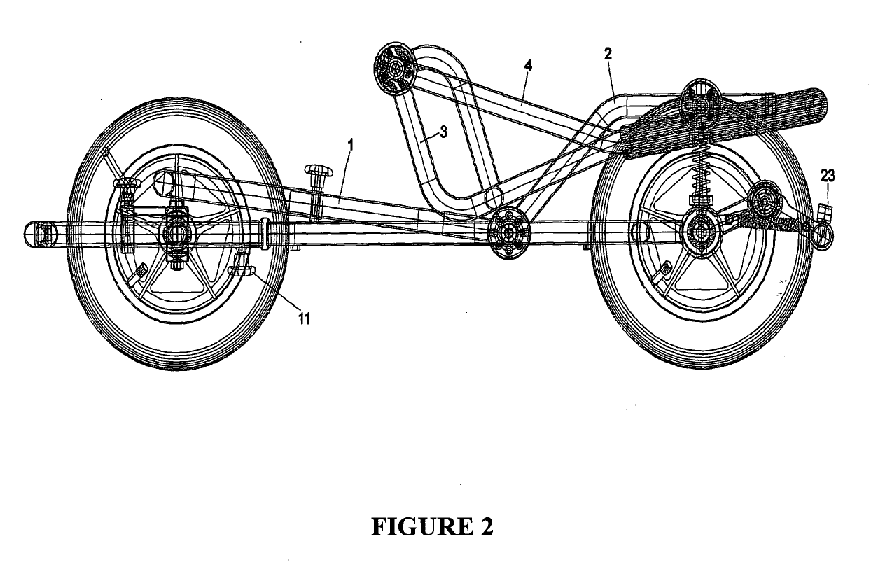

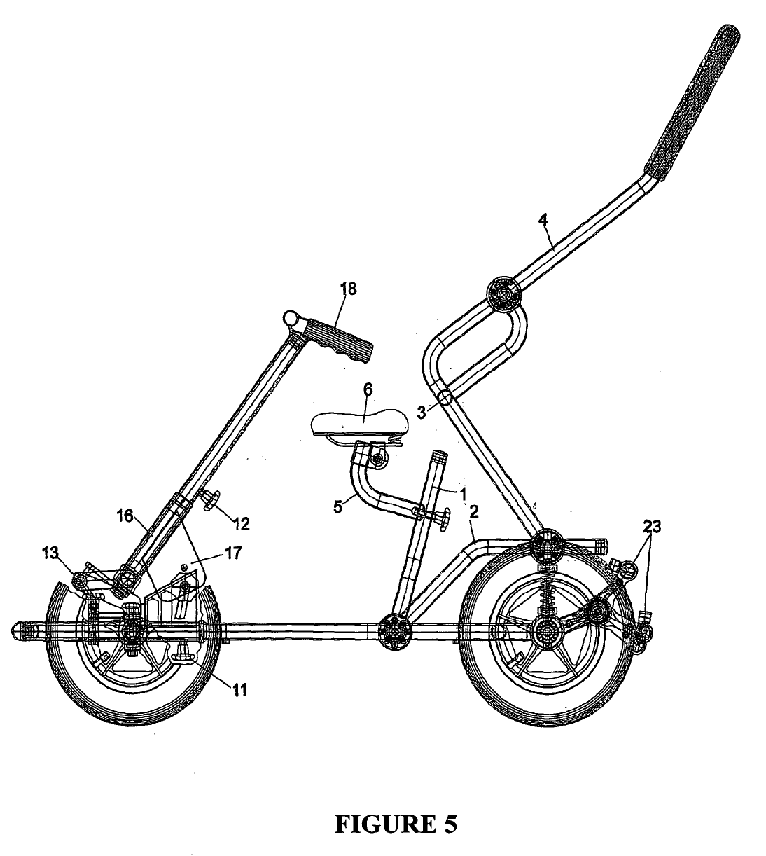

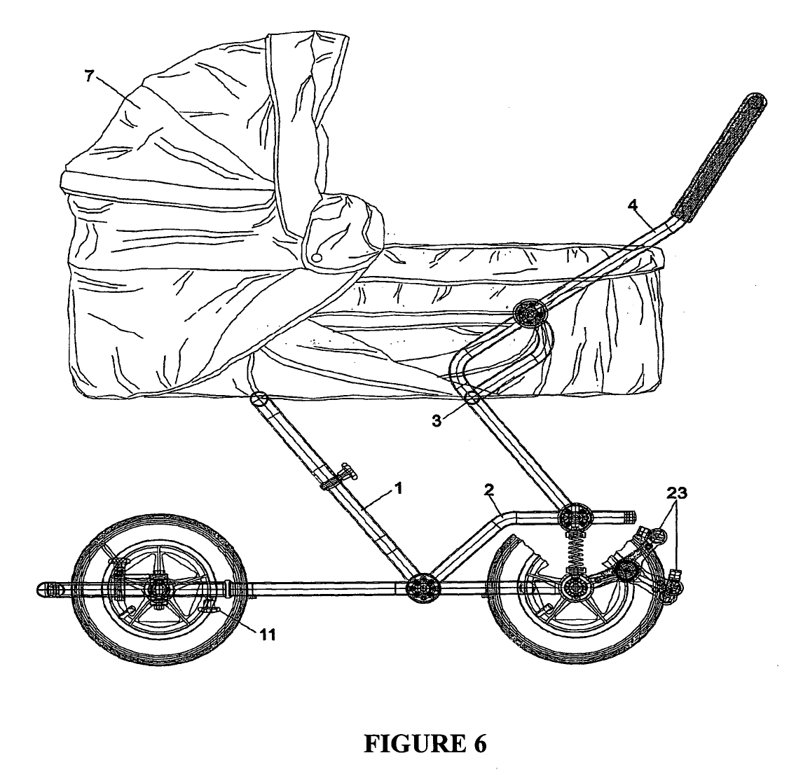

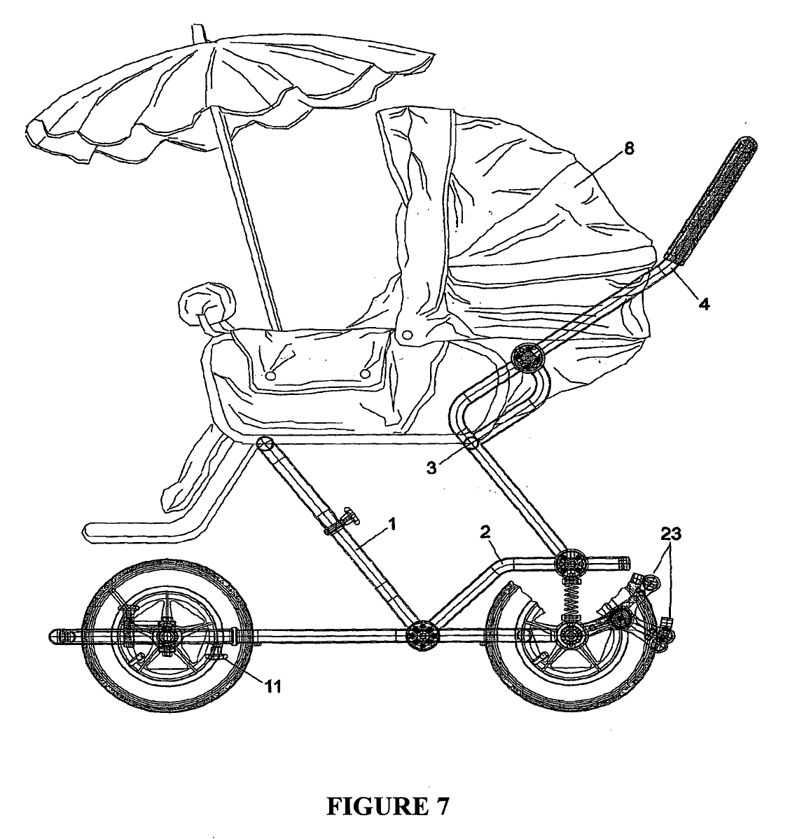

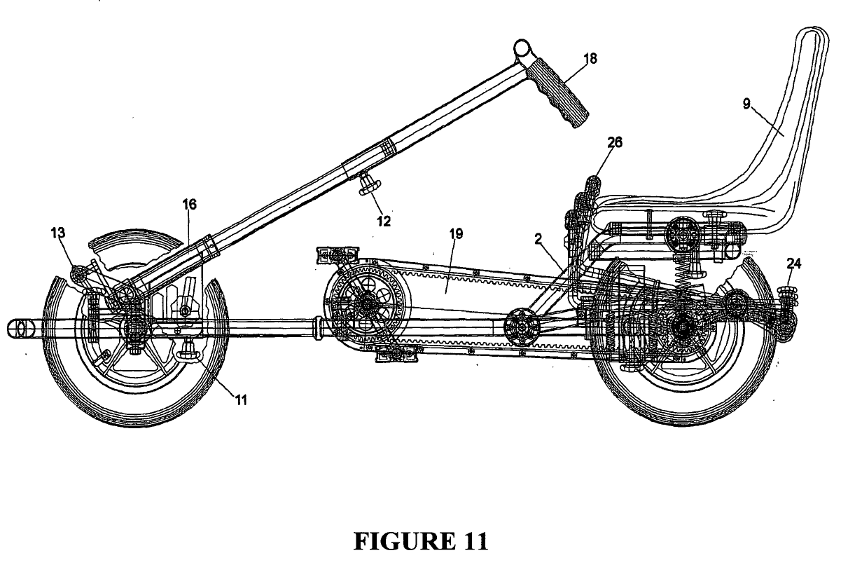

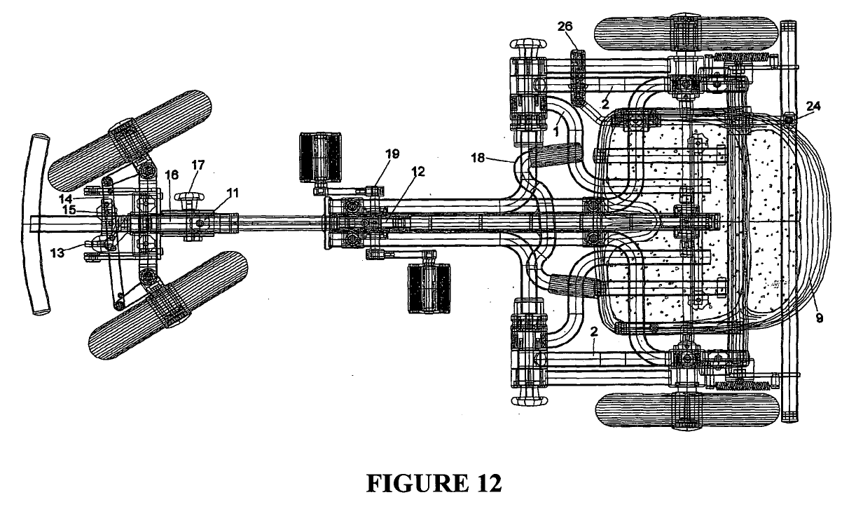

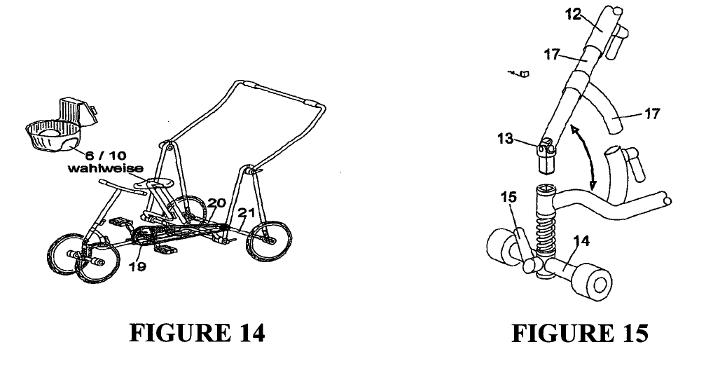

Therefore, a component adjustable in multiple ways, which is identified here as a “universal telescopic pivot bracket” (FIG. 2-13, 1), is illustrated as an example in the drawing. For example, add-ons, such as a pram basket (FIG. 6, 7), stroller seat (FIG. 7, 8), saddle (FIGS. 5+10+13-14, 6), trouser safety seat (FIG. 14, 10) or shell seat (FIG. 11-12, 9), may be alternately mounted thereon in their various required positions, adjusted to the body size of the child, and fixed.

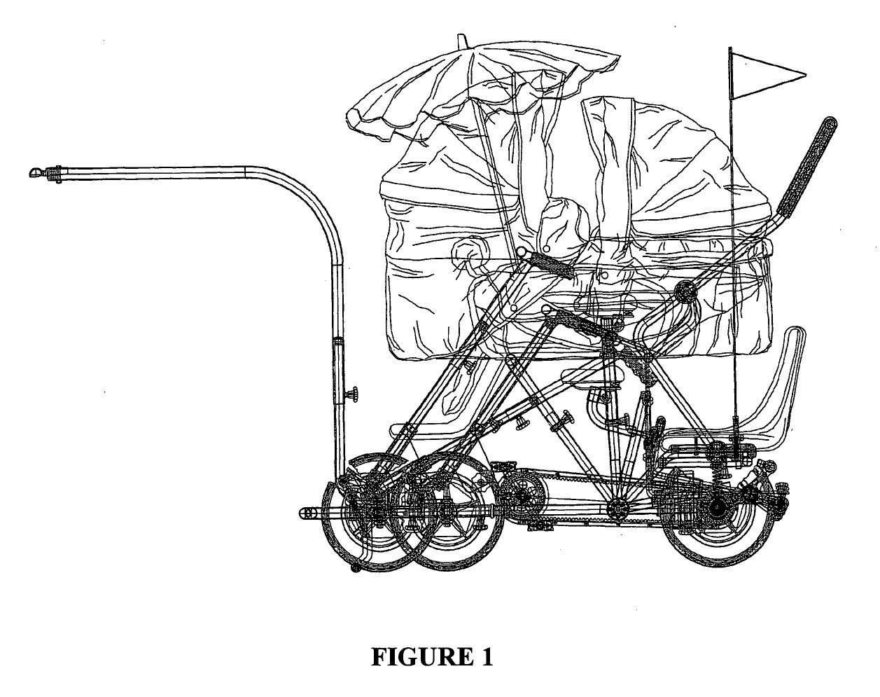

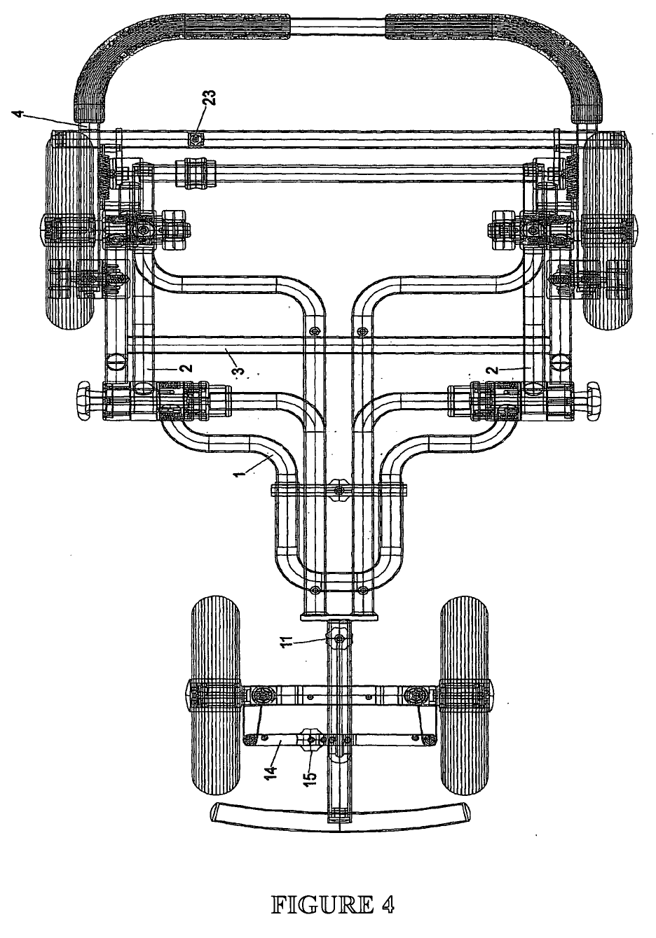

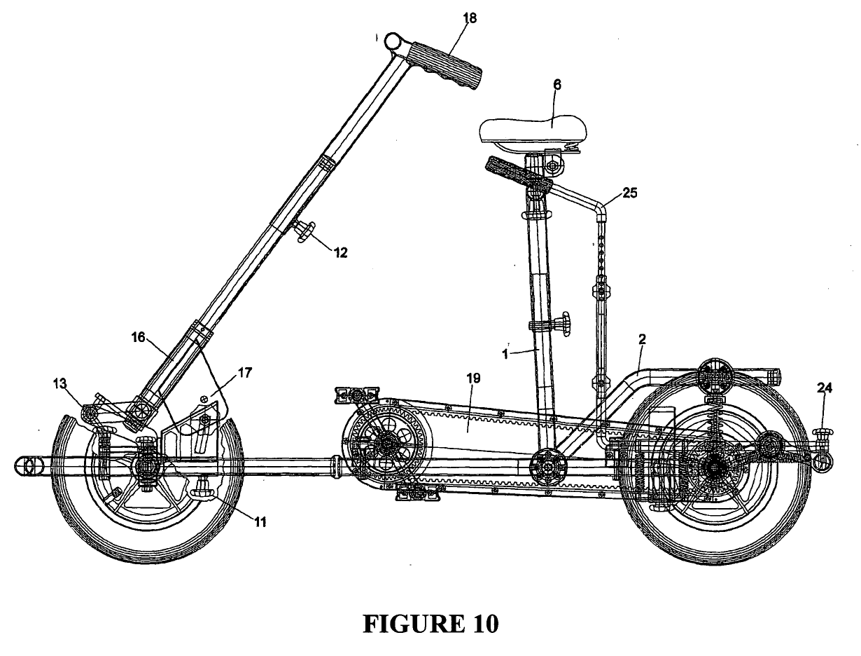

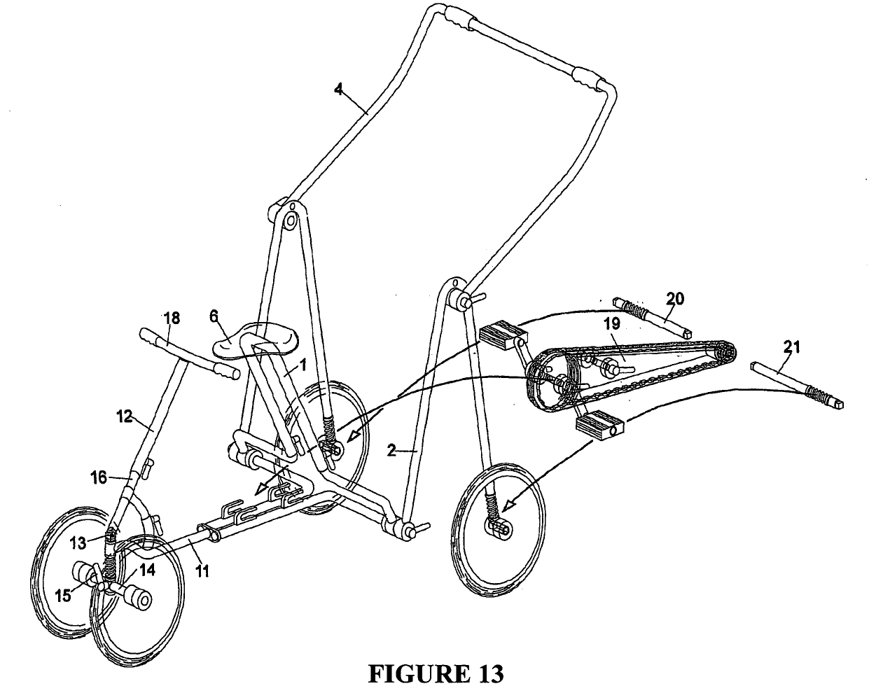

Furthermore, the multifunctional chassis illustrated as an example (FIGS. 1-7+10-12 and FIGS. 13+14) is distinguished in that a steerable axis (FIGS. 4+12-13+15, 14) may alternately either be set in function or locked (FIGS. 4+12-13+15, 15) on the desired structure depending on the particular required use. In addition, a mechanical receptacle is located on this chassis for the simple insertion and securing of a pivoting-telescoping steering module including an incline bearing pivot bracket (FIGS. 5+10-13+15, 16-17) and steering wheel (FIGS. 5+10-13, 18), from which it is possible for the child of appropriate age to steer the various types of vehicles (FIGS. 10-14) from his particular seat positions. The pivoting-telescoping steering module, which is adjustable in all required directions, also makes a chassis of this type a high-quality universal solution. A chassis usable in multiple ways in the meaning of the present invention may clearly also be implemented using simple mechanical designs.

In addition, the present invention comprises a drive module usable as needed, shown as an example in the drawings (FIGS. 10-14) as a pedal-belt drive module (FIGS. 10-14, 19). Through simple insertion and (for example) clamping screws in connection with a driveshaft (FIG. 13, 20-21), which is also insertable, this module allows a drive of a chassis adequate for go-cart to be implemented, it being left to the producer to implement the force transmission to the drive axle alternatively via chain(s), push rod(s), gearwheels, propeller shaft(s), etc., which may be combined similarly to form a suitable module. Simpler solutions may also provide a (possibly also removable) pedal crank direct drive of the front wheel, as is typical in tricycles.

An illustrated exemplary embodiment additionally provides the modular conversion of the parking brake (FIGS. 4-9, 23), which is obligatory or advisable in pram, stroller, walking learning aid, or trailer operation, to a driving operation brake (FIGS. 10-12, 24), operable by the child in tricycle and go-cart operation. This is achieved in the present example by using a corresponding convertible lever (FIG. 10, 25; FIGS. 11-12, 26). The pre-tensioned springs of the parking brake do not have to be dismounted for this purpose, because the convertible lever (FIG. 10, 25; FIGS. 11-12, 26) used is in turn impinged by a force, acting opposite to this spring force, of a spring installed pre-tensioned in an additional guide housing, which is large enough to lift the brake shoes off of the wheel in the rest state. The braking action is thus first transmitted to the wheels by the tension force to be applied by the child to the brake lever.

In general, the claimed multifunctional usage of the chassis (FIGS. 1-14) in the particular detail is to be achieved by manifold technical means and—notwithstanding the usage “tricycle”, is not connected to the number of wheels, the type of steering, axle or wheel distances, etc.

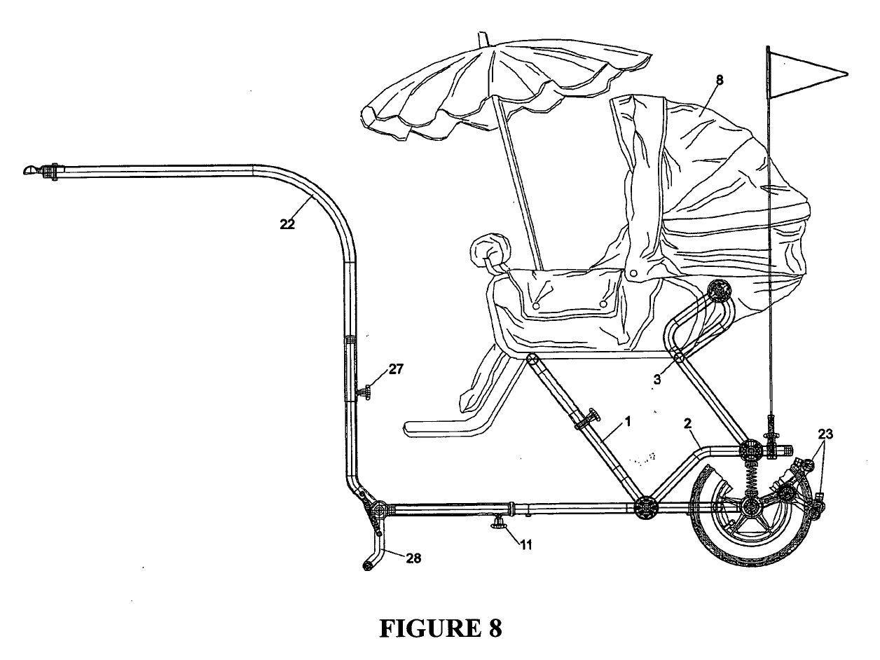

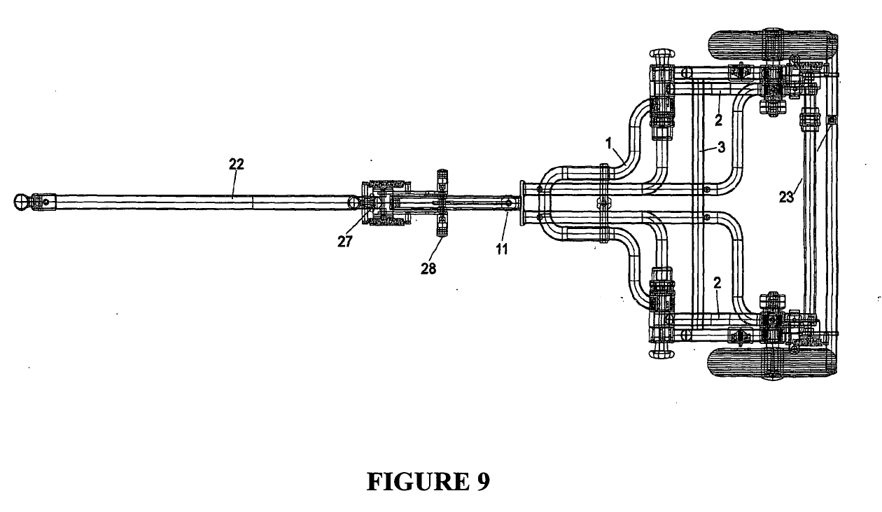

This modularly constructible vehicle palette also comprises vehicles provided for traction operation (i.e., vehicle is pulled in the normal operating case). These include a trailer which may be referred to as a “baby trailer” (FIGS. 8-9), which may be pulled behind a bicycle or a similar vehicle, for example. The principle of allowing traction operation, in that an axle of the chassis is replaced with a trailer drawbar (FIGS. 8-9, 22) (cf. FIG. 7 with FIG. 8), or is possibly also only raised and/or supported by a drawbar-like device, may be implemented in principle using all multi-axle (in particular two-axle) modular vehicles, as are shown as examples in FIG. 5 through FIG. 7 and FIG. 10 through FIG. 11. Appropriate possibilities for securing the child may be provided for safe driving operation (e.g., handles, foot supports, seat shells, safety belts, inter alia, but also lighting units, reflectors, etc.). The steerable axle (FIGS. 4+12, 14), to be integrated in a multifunctional chassis, which is provided in operation adequate for a go-cart and/or tricycle, inter alia (FIG. 10-12), also allows, however, this steering function to be used via a corresponding flanged-on traction drawbar instead of using handlebars or a steering wheel. If needed, all modular vehicles of this type may thus be operated as two-axle or multi-axle steered trailers or also as corresponding special hand carts if needed.

All the disclosed vehicle types, as a result of their modular construction, may be easily folded-up and/or rapidly disassembled for transport and storage.

More specifically, FIG. 1 shows a chassis with the various variants of a child vehicle in illustrations projected one on top of another (simulation), i.e., the projection of FIG. 6 (pram), FIG. 7 (stroller), FIG. 8 (baby trailer), FIG. 10 (tricycle), and FIG. 11 (go-cart).

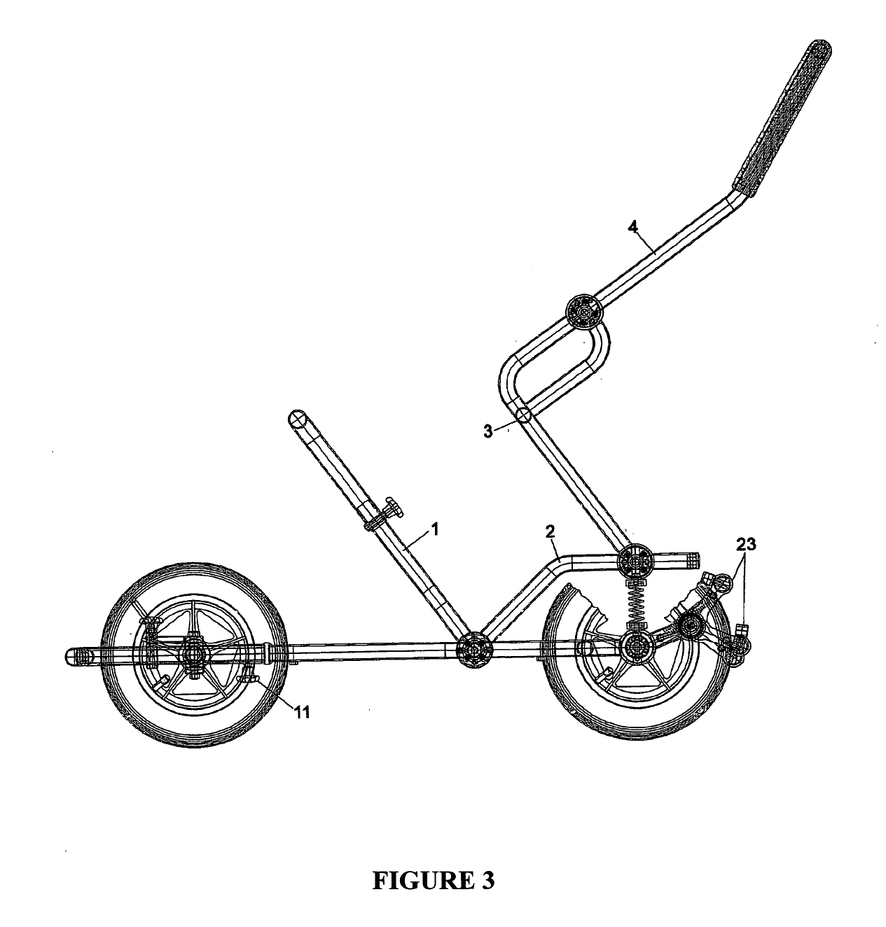

A chassis having a modular basic construction is shown in FIGS. 2 through 4, which comprises a chassis telescopic extension 11, a spring bracket 2 fastened thereto, two rear wheels 32 (only the frontmost wheel visible), and a multifunction bracket 1 fastened thereon, which is adjustable by pivoting and in length and may be fixed in various positions. The rear wheels 32 are each suspended individually sprung on the chassis on axle sections 31 lying in the same axle. The spring bracket 2 is supported on each of the axle sections 31 using a compression spring 30 (cf. FIG. 4 and FIG. 2 or 3). In the embodiment as a walking learning aid (FIG. 5), as a pram (FIG. 6), and as a stroller (FIG. 7), a push bracket carrier tube 3 is additionally provided on the chassis, to which a push bracket 4, which is adjustable in its length and/or inclination, is fastened. Furthermore, a steering axle 14 having two front wheels 34 situated on a shared axle 33 is fastened so it may be plugged on and removed for these three embodiments. The steering axle 14 is locked in its steering ability by a steering lock 15, made of screws, bolts, alignment pins, or closure mechanisms or the like, i.e., the steerable front wheels 34 are oriented fixed in the longitudinal direction like the rear wheels 32. The wheels 32, 34 of the rear and/or front axle are thus mounted so they are rotatable on a suspension standing vertically in the operating state of the chassis. Furthermore, a parking brake 23 having pre-tensioned springs acts in a known way on the rear wheels 32 (cf. FIGS. 2 and 3). The push bracket 4 may fulfill the function of an rollover bracket in a specific lockable position. The axial distance of the front wheels 34 and/or the vehicle length may be varied using the chassis telescopic extension 11.

As is obvious from FIGS. 2 and 3, the chassis may be folded up easily and rapidly for transport and/or storage or at least disassembled easily and in a space-saving way into transportable parts without the use of further tools.

FIG. 5 shows the chassis in the embodiment of a walking learning aid, in which the multifunction bracket 1 is locked in a position slightly diagonal to the vertical and a saddle 6 is fastened thereon using an adjustable saddle support 5. Furthermore, a pivotable steering column 16 is linked to the steering axle 14 using a force-transmitting joint 13. For this purpose, a mechanical receptacle is provided on the chassis, to insert the steering column 16 easily and secure it on the steering axle 14. Using an incline bearing pivot bracket 17, which is fastened to the steering column 16, the inclination may be set and fixed. Furthermore, the steering column 16 is provided with a handlebar 18 and is extendable by a telescopic extension 12. The steering column 16, the pivot bracket 17, and the telescopic extension 12 together form a pivoting-telescoping steering module. The steering may thus be adapted appropriately to the age of a child and his particular seat position. The pivoting-telescoping steering module, which is adjustable in all required directions, represents a high-quality universal solution for the various types of vehicles. Multiple usable chassis in the meaning of the present invention may obviously already be implemented by simpler mechanical designs.

FIG. 6 shows a pram having the chassis described above in FIGS. 3 and 4, on which a pram bed or pram basket 7 is fastened as an add-on to the multifunction bracket 1 and to the push bracket carrier tube 3.

FIG. 7 shows a stroller having the chassis described above in FIGS. 3 and 4, on which a stroller reclining seat 8 is fastened as an add-on to the multifunction bracket 1 and to the push bracket carrier tube 3.

FIGS. 8 and 9 show a trailer referred to as a “baby trailer”, which may be pulled behind a bicycle or a similar vehicle, for example. The front wheels 34 with the steering axle 14 are replaced for this purpose by a trailer drawbar 22, which is flanged onto the chassis telescopic extension 11. The drawbar 22 has a telescopic extension 27, using which it is adjustable in its height and/or length. Furthermore, a stand 28, which may be folded down or lowered in another way, is provided on the drawbar 22 to park the trailer.

FIG. 10 shows the embodiment of a tricycle in which a single front wheel 34 is provided. For this purpose, a pedal-belt drive module or pedal drive module 19 is attached to the chassis, which has a gearwheel having pedals, a drive gearwheel, and a toothed belt. Insertable driveshafts 20 and 21 (see FIG. 13) are provided on the pedal drive module 19. These driveshafts 20 and 21 are fastened to the rear wheels 32 by simple insertion or by clamping screws. The pedal drive module 19 may also transmit the force to only one wheel. The pedal drive module 19 also has a free wheel which may be switched in or is permanent and a stepped or continuously variable transmission. The force transmission may alternatively be implemented via chains, push rods, gearwheels, propeller shafts, and the like, which may be combined similarly to form a suitable module. Simpler solutions may also provide a possibly also removable pedal crank direct drive of the front wheel, as is typical in tricycles. A tricycle brake lever 25 having a spring installed pre-tensioned in an additional guide housing is operationally linked to the parking brake 23 as a driving operation brake 24. The pre-tensioned springs of the parking brake 23 do not have to be dismounted for this purpose, because the convertible lever 25 counteracts the springs of the parking brake 23 with its spring force, which is large enough to lift the brake shoes of the parking brake 23 off of the wheel in the rest state. The braking action is thus first transmitted to the wheels by the tension force to be applied by the child to the brake lever 25.

FIGS. 11 and 12 show the embodiment of a go-cart, in which the chassis of FIGS. 2 and 3 is visible and, similarly as in FIG. 10, a pedal-belt drive module 19 is provided. A shell seat 9 is fastened here to the multifunction bracket 1 (cf. FIG. 12). The steering column 16 is engaged and fixed at a greater inclination to the chassis telescopic extension 11 using the pivot bracket incline bearing 17. In this case, a shorter go-cart brake lever 26 is provided, which acts on the parking brake 23 as the driving operation brake 24 similarly to the tricycle brake lever 25. Three different positions of the brake lever 26 and the driving operation brake 24 are visible in FIG. 11. The brake system may also be implemented in such a way that it is operable from various points via operating elements which are mounted fixed (levers, Bowden pull wires, rods, and the like) and may thus be actuated as a function of the particular use of the chassis by the accompanying person, by the child, or by both jointly. The operating elements of the brake system are preferably linked to one another in such a way that a priority in favor of the accompanying person results. This may be performed by decoupling the subordinate operating elements by the main operating element, which first actuates a corresponding coupling element in the range of its idle stroke path and only applies the braking force to the brake elements in the course of the further operating path. The steering may contain a propeller joint, flexible shaft, a gearwheel pair, or another pair of elements, which is preferably connected non-positively or also friction-locked.

FIG. 13 shows an alternative embodiment of the tricycle in a perspective illustration, in which the chassis is used with two front wheels 34. Furthermore, the adjustable push bracket 4 for teaching driving is provided here.

In FIG. 14, a trouser safety seat 10 is provided as an alternative instead of a saddle 6 for smaller children. FIG. 15 shows further details of the steering column 16, which is adjustable in its length and inclination.

It is obvious to those skilled in the art that the typical seating possibilities to be mounted for the particular use, such as saddle 6, trouser safety seat 10, or shell seat 9, may be adapted to the body size of the child in regard to different positioning using oblong holes, multiple receptacle holes, telescopic devices, pivot mechanisms, and the like.

In principle, the front axle of all multi-axle modular vehicles described above may be replaced by a trailer drawbar 22 or the chassis may also only be raised and/or supported by a drawbar-like device. Appropriate safety capabilities for the child, such as handles, foot supports, seat shells, safety belts, or the like, but also lighting units, reflectors, etc., are provided for safe driving operation. The steering axle 14 to be integrated in a chassis provided for go-cart or tricycle operation also allows, however, this steering function to be used via a corresponding flanged-on traction drawbar instead of a handlebar or a steering wheel. If needed, all modular vehicles of this type may be operated as a two-axle or multi-axle steered trailer or also as a corresponding special handcart. The drawbar 22 may also have a retainer for a tray or a similar shelf.

A receptacle may be provided on the chassis of the modular vehicles to attach and fasten a transport container thereon.

1-32. (canceled)

33. A chassis for a child vehicle having wheels and being convertible into various embodiments, wherein the chassis has a modular basic construction and comprises:
a chassis telescopic extension,
a spring bracket fastened to the chassis telescopic extension,
two rear wheels, and
a multifunction bracket that may be fixed in various positions, the multifunction bracket being adjustable by pivoting and in length on the chassis telescopic extension.

34. The chassis of claim 33, wherein the rear wheels are each individually suspended on the chassis on one axle section.

35. The chassis of claim 33, further comprising a trailer drawbar that is flanged onto the chassis telescopic extension.

36. The chassis of claim 35, wherein a stand, which may be folded down or lowered, is provided on the trailer drawbar.

37. The chassis of claim 33, further comprising a steering axle having two front wheels flanged onto the chassis telescopic extension.

38. The chassis of claim 37, wherein the steering axle is provided with a steering lock.

39. The chassis of claim 33, further comprising a parking brake, which acts on the rear wheels using pre-tensioned springs.

40. The chassis of claim 39, further comprising a driving operation brake, which is operable using a lever, the driving operation brake being operationally linked to the parking brake using a pre-tensioned spring acting in the opposite direction whereby the parking brake is lifted off of the rear wheels in a rest state.

41. A child vehicle comprising a chassis of claim 33, wherein the chassis further comprises:
a push bracket support tube, and
a removable push bracket attached to the push bracket support tube, the push bracket being adjustable in its length and/or inclination.

42. The child vehicle of claim 41, wherein the vehicle further comprises a pram bed mounted on the multifunction bracket and the push bracket support tube.

43. The child vehicle of claim 41, wherein the vehicle further comprises a stroller reclining seat mounted on the multifunction bracket and the push bracket support tube.

44. A child vehicle comprising a chassis of claim 37, wherein a steering device operable by the child is connected to the steering axle.

45. The child vehicle of claim 44, wherein the steering device comprises a handlebar having a pivotable steering column, which may be engaged and fixed in its inclination by a pivot bracket.

46. The child vehicle of claim 45, wherein the steering column is extendable and fixable in at least two positions via a telescopic extension.

47. The child vehicle of claim 44, further comprising a pedal drive module provided on the chassis for force transmission to the rear wheels.

48. The child vehicle of claim 47, wherein the pedal drive module comprises a gearwheel having pedals, a drive gearwheel, and a toothed belt.

49. The child vehicle of claim 47, wherein insertable driveshafts for the rear wheels are provided on the pedal drive module.

50. The child vehicle of claim 47, wherein the pedal drive module has a freewheel which may be switched in or is permanent.

51. The child vehicle of claim 47, wherein the pedal drive module has a stepped or continuously variable transmission.
